(19) United States
(12) Patent Application Publication
(10) Pub. No.: US 2025/0084265 A1
(43) Pub. Date: Mar. 13, 2025

(54) DIRECT INK WRITE ADDITIVE MANUFACTURING OF THERMOPLASTIC POLYMERS AND THERMOPLASTIC POLYMER COMPOSITES AT AMBIENT CONDITIONS

(71) Applicant: Lawrence Livermore National Security, LLC, Livermore, CA (US)

(72) Inventors: Fangyou Xie, Rosemead, CA (US); Colin Kane Loeb, Fairfield, CA (US)

(21) Appl. No.: 18/367,968

(22) Filed: Sep. 13, 2023

(51) Int. Cl. C09D 11/102; B29C 64/118; B33Y 10/00; B33Y 70/00; B33Y 80/00; C09D 11/033

(52) U.S. Cl. CPC C09D 11/102; B29C 64/118; B33Y 10/00; B33Y 70/00; B33Y 80/00; C09D 11/033; B29K 2069/00; B29K 2079/085

(57) ABSTRACT

An ink includes a thermoplastic polymer and a solvent selected to melt the thermoplastic polymer. A method includes forming a three-dimensional (3D) structure using an ink, the ink includes a thermoplastic polymer and a solvent selected to melt the thermoplastic polymer. The method includes removing the solvent from the 3D structure, where the thermoplastic polymer remains substantially in the shape of the formed 3D structure after removal of the solvent.

This invention was made with Government support under Contract No. DE-AC52-07NA27344 awarded by the United States Department of Energy. The Government has certain rights in the invention.

### FIELD OF THE INVENTION

The present invention relates to thermoplastic polymer composites, and more particularly, this invention relates to additive manufacturing of thermoplastic polymer composites at ambient conditions.

### BACKGROUND

An amorphous thermoplastic resin such as polyetherimide (PEI, brand name Ultem®) is an engineering thermoplastic that is widely used in aerospace and automotive industries due to its high strength, and thermal stability. For example, Ultem® is inherently a flame-retardant offering UL94 V0 and 5V ratings and aerospace FAR 25.853 compliance. Some grades of this material are also used in biomedical and food industries due to its chemical stability and ability to be sanitized by autoclave.

Traditional manufacturing of thermoplastic polymer parts use injection molding at high temperature to melt the thermoplastic polymer material for setting a part structure. The only known additive manufacturing (AM) techniques used with thermoplastic polymer resin (e.g., PEI, Ultem®) include fused deposition modeling (FDM) and selective laser sintering (SLS). These two AM processes require high temperatures (c.a. 360° C.) to melt the material and methods to rapidly cool the material to set the structure and produce an AM part. The high temperatures needed to melt thermoplastic polymer resins limits the chemistry of fillers, co-polymers or additives to components that are stable above the melting temperature of the thermoplastic polymer resin. For example, composites of PEI with rubbers for composite toughening are not used due to the degradation temperature of most rubbers being lower than the melting point of PEI. Furthermore, organic additives, such as plasticizers and antioxidants, are limited due to the degradation temperature of these small molecules. Additive manufacturing of thermoplastic polymer resins at ambient pressures and temperature would therefore provide for more control of the polymer and composite chemistry by removing the limits created by current high temperature melt process.

### SUMMARY

In one embodiment, an ink includes a thermoplastic polymer and a solvent selected to melt the thermoplastic polymer.

In another embodiment, a method includes forming a three-dimensional (3D) structure using an ink, the ink includes a thermoplastic polymer and a solvent selected to melt the thermoplastic polymer. The method includes removing the solvent from the 3D structure, where the thermoplastic polymer remains substantially in the shape of the formed 3D structure after removal of the solvent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 depicts examples of aromatic thermoplastic polymers.

FIG. 2 is a flow chart of a method of forming a three-dimensional structure using ink comprising a thermoplastic polymer, according to one embodiment.

FIG. 3 are images of an ink being extruded to form a three-dimensional structure, according to one embodiment. Part (a) is an image of the cartridge containing the ink with the nozzle attached to the cartridge, part (b) is an image of the ink being extruded from the nozzle to form a self-supporting cylindrical structure, and part (c) is an image of the self-supporting cylindrical structure of thermoplastic polymer composite material after the solvent has been removed from the composite material.

FIG. 4 is a series of sequential images of an ink being extruded with an air stream directed at the extruding ink, according to one embodiment. Parts (a) and (b) are images of the extruding filament forming a cylindrical layer, parts (c) and (d) are images showing the extruded filament is a solid and does not change shape after a tap from the forceps.

FIG. 5 is a series of images depicting the formation of a three-dimensional structure comprising a thermoplastic polymer with high porosity, according to one embodiment. Part (a) is an image of a structure formed by extrusion of the ink under a closed environment, and part (b) is an image of the structure after application of heat to rapidly evaporate the solvent from the composite.

FIG. 6A is an image of a complex lattice structure comprised of a thermoplastic polymer printed with dimensional accuracy, according to one embodiment.

FIG. 6B is an image of a complex structure comprised of thermoplastic polymer printed with dimensional accuracy, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is noted that ambient room temperature may be defined as a temperature in a range of about 20° C. to about 25° C.

It is also noted that, as used in the specification and the appended claims, wt. % is defined as the percentage of weight of a particular component is to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive approaches described herein. It should be understood that “inks” (and singular forms thereof) may be used interchangeably and refer to a composition of matter comprising a composition of matter may be “written,” extruded, printed, or otherwise deposited to form a layer that substantially retains its as-deposited geometry and shape without excessive sagging, slumping, or other deformation, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of the ink (or in some cases multiple inks with different compositions) in sequence.

The following description discloses several preferred structures formed via direct ink writing (DIW), extrusion freeform fabrication, or other equivalent techniques and therefore exhibit unique structural and compositional characteristics conveyed via the precise control allowed by such techniques. DIW involves the forcing of an “ink” or paste-like material through a nozzle while moving a substrate beneath the nozzle whose motion creates a pattern to the strand. Parts are printed by layering the strands into a three-dimensional (3D) object, with or without porosity. The part retains a microstructure formed during printing due to a complex thixotropic rheology of the ink. The ink then cures either during or post printing to form a permanent shape.

The following description discloses several preferred embodiments of thermoplastic polymer composites for direct ink writing at ambient conditions and/or related systems and methods.

In one general embodiment, an ink includes a thermoplastic polymer and a solvent selected to melt the thermoplastic polymer.

In another general embodiment, a method includes forming a three-dimensional (3D) structure using an ink, the ink includes a thermoplastic polymer and a solvent selected to melt the thermoplastic polymer. The method includes removing the solvent from the 3D structure, where the thermoplastic polymer remains substantially in the shape of the formed 3D structure after removal of the solvent.

A list of acronyms used in the description is provided below.
3D Three-dimensional
AM Additive manufacturing
C Celsius
DIW Direct Ink Writing
DMSO dimethylsulfoxide
DP droplet printing
FDM fused deposition modeling
g gram
kg kilogram
m²/g meter squared/gram
mm millimeter
mol. % mole percent
NMP N-methylpyrrolidone
PEI polyetherimide
S seconds
SLS selective laser sintering
THF tetrahydrofuran
wt. % weight percent

Conventional processing of thermoplastic polymers includes melting the thermoplastic polymers at high temperatures for extrusion, injection molding, etc. to form defined shapes. According to various embodiments described herein, additive manufacturing techniques may be used to form complex geometries and shapes of thermoplastic polymers at lower temperatures, and preferably, at ambient temperatures. In one embodiment, processes and conditions are described in which a high strength thermoplastic polymers may be printed by direct ink write (DIW) and droplet printing (DP) additive manufacturing (AM) at ambient conditions. In one example, thermoplastic polymers such as a polyetherimide (PEI) engineering thermoplastic composite may be printed by DIW AM techniques at ambient conditions.

According to one embodiment, for DIW, DP, etc. printing processes, a thermoplastic polymer resin may be converted to an ink by solvent-melting the thermoplastic polymer resin with a solvent that is configured to evaporate quickly to set the printed structure. In various approaches, a commercially available thermoplastic polymer may be dispersed in organic solvents to create a solvent-melt dispersion that is amenable to DIW due to inherit evaporation-gated thixotropy. In one example, the engineering thermoplastic polymer includes PEI (e.g., brand name Ultem® 1010) and the complementary solvent includes THF.

As described herein, a solvent is absorbed by the thermoplastic polymer causing the polymer structure to soften and lose rigidity thereby transitioning into a phase. The solvent solvates the thermoplastic polymer by becoming incorporated in the polymer structure, disrupting a portion of polymer-polymer interactions and allows for displacement between polymer chains. The solvent may be defined as a solvent complementary to the structure of the thermoplastic polymer. Without wishing to be bound by any theory, the inventors believe the solvent-polymer interaction includes coordinating partial charges, although not fully ionic, and thus, the solvent may be defined as a coordinating solvent. In the presence of the solvent, the thermoplastic polymer undergoes a physical change but does not undergo a chemical change. A thermoplastic polymer mixed into a complementary solvent changes from a solid phase of thermoplastic polymer to a liquid solvent-melt phase of thermoplastic polymer. In one example of PEI/THF, the liquid solvent-melt is a Newtonian viscous liquid. The solvent-melt does not undergo shear-thinning and is not thixotropic.

According to one embodiment, an ink includes a thermoplastic polymer and a solvent. A thermoplastic polymer is typically processed above ambient temperatures. A thermoplastic polymer may be aromatic, aliphatic, non-halogenated, halogenated, organic, or inorganic in nature. The thermoplastic polymer may be an aromatic thermoplastic polymer having a chemical structure that includes a repeating unit having at least one aromatic rings. Dispersal of the thermoplastic polymer in a complementary solvent exists as a liquid phase, being a highly viscous solvent-melt. A solvent may be defined as being complementary because the solvent is uniquely selected to melt the aromatic thermoplastic polymer. The solvent is selected to melt the aromatic thermoplastic polymer upon mixing the solvent with the thermoplastic polymer at ambient temperatures. While the solvent and the thermoplastic polymer are being mixed together, and the solvent and the thermoplastic polymer are present together in a mixture, the thermoplastic polymer exists in a melted phase, e.g., a solvent-melt. A preferred selected solvent has physical properties such as evaporation in the presence of air, evaporation under applied pressure and/or applied heat, diffusion in a solvent having higher miscible properties than the polymer, etc. In one example, a polyetherimide (PEI) thermoplastic polymer has a chemical structure that is complemented by the solvent THF thereby resulting in a solvent-melt phase of dispersed the PEI thermoplastic polymer in THF solvent.

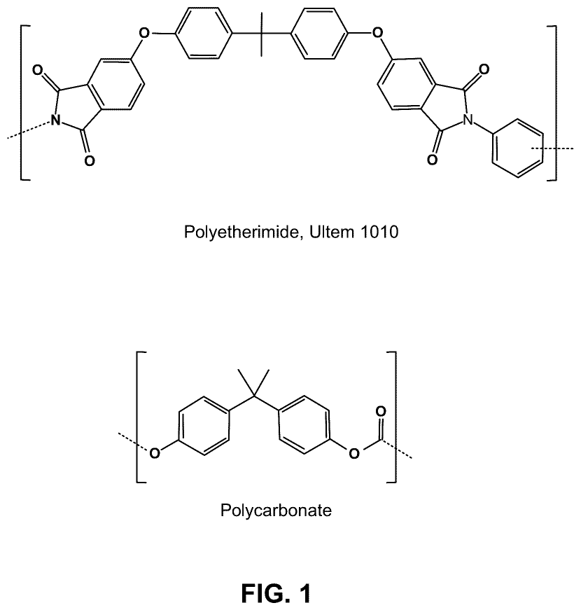

In various approaches, a thermoplastic polymer may include polyvinyl alcohol, PEI, aromatic PEI, polycarbonate, etc. that are characterized by having an aromatic structure. As illustrated in FIG. 1, a thermoplastic polymer may have a repeating unit having at least one aromatic ring, e.g., PEI, polycarbonate, etc. In various approaches, a thermoplastic polymer may include thermoplastic PEI, neat PEI (e.g., PEI is unmixed with any other polymer), a highly aromatic PEI, the Ultem® resin family, such as Ultem1010, Ultem9450 which includes polycarbonate, etc. In some approaches, a thermoplastic polymer may include polycarbonate, polyetheretherketone (PEEK), polylactic acid (PLA), polyethylene terephthalate (PETG), acrylonitrile styrene acrylate (ASA), acrylonitrile butadiene styrene (ABS), polyvinyl chloride (PVC), nylon, polyamide, polyester, polystyrene, polypropylene (PP), polyvinylacetate, etc.

A solvent may be selected according to the chemical structure of the thermoplastic polymer. A solvent selected to melt a thermoplastic polymer may include THF, acetone, DMSO, etc. Preferably, the solvent(s) is removeable from the solvated thermoplastic polymer by evaporation when exposed to air, or alternatively removed by diffusion in a miscible solvent (e.g., water). Preferred properties of the solvent include the ability to form a viscous ink composition with the thermoplastic polymer, and then evaporation from the polymer during exposure to air, diffusion of the solvent from the polymer mixture in a solvent exchange bath, e.g., a water bath, etc. For example, without wishing to be bound by any theory, the inventors believe the chemical structure of PEI has an arrangement of polymer chains that includes specific regions of appropriate size, shape and electronic environment within the bulk polymer for THF solvent molecules thereby allowing formation of a viscous ink mixture, and the structure allows evaporation of the THF molecules from the polymer structure upon exposure to air, diffusion of THF molecules away from the polymer structure in a water bath, etc.

In some approaches, a solvent may be selected according to the chemical structure of the thermoplastic polymer. In one example, the solvent tetrahydrofuran (THF) is selected for forming a solvent-melt with a thermoplastic polymer PEI. In preferred approaches, a mixture of the thermoplastic polymer dispersed in a selected solvent produces a viscous solvent-melt that may be compounded with added components. In another approach, the mixture of the thermoplastic polymer dispersed in a selected solvent may be used in AM printing processes without added components.

According to one approach, a solvent may be selected according to the chemical structure of the thermoplastic polymer and the arrangement of polymer chains of the thermoplastic polymer, such that dispersing the thermoplastic polymer in the selected solvent generates a high viscosity solvent-melt mixture. In one example, the solvent tetrahydrofuran (THF) mixed with the thermoplastic PEI (e.g., Ultem®) generates a high viscosity solvent-melt thermoplastic material at ambient conditions. The mixture may include additional components for forming a desired composite material.

In one approach, a polycarbonate polymer may be soluble in its selected solvent that is complementary to the chemical structure of the polycarbonate polymer. For example, an ink may include polycarbonate as the aromatic thermoplastic polymer and acetone as the solvent selected to melt the polycarbonate. A polycarbonate polymer has a coordinate structure that includes regions specific for acetone solvent molecules, thereby allowing formation of a viscous ink mixture. After printing the polycarbonate/ink, upon exposure of the extruded polycarbonate/acetone structure to air, the acetone may be removed by evaporation and the extruded structure is comprised of solid polycarbonate material.

In one embodiment, an ink may include a thermoplastic polymer and selected solvent in a weight ratio of 100:1 to at least 1:100. In some approaches, the weight of the solvent is in excess of the weight of the thermoplastic polymer. The ink may be mixed at an elevated temperature in a range of 40 to 50° C., for a duration of time for dispersing the thermoplastic polymer in the selected solvent for forming a homogenous mixture. In some approaches, the ink may be mixed at the elevated temperature for approximately 12 hours. The homogenous mixture forms a gel that has a defined viscosity, where the viscosity may be raised or lowered by adjusting the temperature of the mixture. The viscosity at ambient temperature is defined by the coordinating structure of the thermoplastic polymer in a selected solvent. A coordinating structure includes polymer-polymer interactions and polymer-solvent interactions. Once the thermoplastic polymer and solvent become a homogenous mixture, e.g., a solvent-melt, the temperature may be lowered to an ambient temperature, e.g., room temperature.

In one example, a thermoplastic polymer Ultem®/PEI is mixed to a solvent-melt in the selected solvent THF in a 40:60 ratio by weight. The ink is mixed in a closed environment under nitrogen so that the volatile solvent THF does not escape the ink mixture.

In various approaches, one or more solvents may be included in preparation a thermoplastic polymer to create an ink for DIW. In some approaches, a co-solvent that is different than the solvent selected to melt the thermoplastic polymer may be included for generating a solvent-melt thermoplastic polymer for forming an ink for DIW. Using a co-solvent may allow the ink viscosity to be tuned and/or may allow tuning the speed at which bulk modulus may be increased after deposition. In some approaches, a thermoplastic polymer resin may be mixed with a mixture of solvents (i.e., more than two co-solvents). A mixture of solvents may include a selected solvent and a co-solvent that is different than the selected solvent, where the co-solvent has greater affinity for the thermoplastic polymer than the selected solvent, so that as the selected solvent leaves the extruded thermoplastic polymer composite material by evaporation, diffusion, etc. the co-solvent remains in the polymer. A co-solvent may result in quicker evaporation, diffusion, etc. of the selected solvent from the extruded thermoplastic polymer material. These properties may be key in tuning the printing parameters for ink for DIW and may be valuable for other applications, such as in the manufacturing of conformal coatings. Co-solvents may include aprotic and protic solvents such as dimethylsulfoxide (DMSO), N-methylpyrrolidone (NMP), 1-decanol, etc.

In various approaches, an ink may include an additive. In one approach, the additive may be a filler. In one approach, an ink for forming a thermoplastic polymer composites may include a functional filler. In one approach, an ink may include a non-functional filler. In another approach, a filler may be added to the ink for forming a composite thermoplastic polymer material.

In some approaches, a functional filler may be added to an ink in order to produce some effect in the ink. In other approaches, a filler may be added to an ink in order to produce some effect in the extruded thermoplastic polymer composite material. In other approaches, a filler may be a non-functional filler. For example, a non-functional filler may be added to an ink in order to lower the volume fraction of expensive components, and thus reduce composite costs. In one approach, a filler may include fibers such as fiberglass, carbon fiber, carbon nanotubes, polymer fibers, natural fibers, ceramic fibers, metal fibers or mixtures thereof. In another approach, a functional filler may include powders such as glass, carbon, polymer, rubber, metals, ceramics, natural powders or mixtures thereof.

In some approaches, an ink may include a filler as a reinforcing component for reinforcing green body parts. In one approach an ink may include a filler that includes a pre-ceramic material. For example, green body printing for forming a ceramic composite may include adding silicon carbide particles to the ink; and at a sufficiently high concentration particles, the particles may connect within the polymer material. The printed polymer/silicon carbide part, i.e., a pre-ceramic part, may be placed in a furnace for pyrolyzing the printed part so that the polymer is burned away thereby forming a ceramic structure as a near net shape of the previously formed (and now burned away) polymer structure. A near-net shape part may be formed using the thermoplastic polymer ink comprised of a functional filler (e.g., the filler is the desired material for the part such as pre-ceramic particles forming a ceramic part). In preferred approaches, a thermoplastic polymer-based ink forms a green body having enhanced durability and mechanical strength compared to a green body part formed using conventional precursors.

In various approaches, an amount of a filler(s) in the ink may include a filler based on weight of the thermoplastic polymer, for example, an amount of filler may be in a range of greater than 0 wt. % up to about 98 wt. % filler based on the total weight of the polymer. An upper range of fillers for forming a pre-ceramic structure for pyrolyzing may include fillers in a range of greater than 0 vol. % up to 70%. vol based on volume of the total polymer/solvent. In a preferred approach, an ink having a filler at 40 vol. % based on the total volume of the polymer/solvent forms a stable, pre-sintered part. However, in some approaches, the amount of filler may be configured according to the amount of polymer included in the ink, so an upper limit of filler relative to the polymer may be 50 vol. % filler based on the amount of polymer present. In an exemplary approach, a final part includes about 20 vol. % of filler based on the amount of polymer present (after evaporation, diffusion, etc. of the solvent from the part).

In one example, the relative amounts of an ink may include:
50 vol. % of thermoplastic polymer:solvent (1:1 ratio according to weight), and
50 vol. % filler.

In a preferred example, the relative amounts of an ink may include:
60 vol. % of thermoplastic polymer:solvent (1:1 ratio according to weight), and
40 vol. % of filler.

In some approaches, a filler may be included in the ink to promote evaporation of the solvent after extrusion. For example, polymer particles, non-dissolvable silicone particles, may allow the solvent to preferentially diffuse out of the thermoplastic polymer resin into the silicone and percolation of the silicone particles allows a new pathway of exodus of the solvent.

In some approaches, an additive may include at least one of a crosslinker, a thermoset material, a photoinitiator, a thermal initiator, radical scavenger, UV blocking agent, pigment, rheological additive, etc. In one approach, the additive may be included in the ink in addition to a filler. In other approaches, an ink may include more than two different additives. In some approaches, an ink may include an additive for affecting a change in the ink. In other approaches, an ink may include an additive that is an initiator that may cause a change (e.g., structural change, a chemical change, etc.) to the polymer/polymer network. For example, an ink may include an additive that is configured to crosslink the thermoplastic plastic at elevated temperatures. In one approach, the change to the polymer/polymer network may reduce (or remove) the ability for the polymer to be solvent melted.

In some approaches, an ink may include a crosslinker that chemically binds chains of a thermoplastic polymer together. A crosslinker may form a chemical bond between chains of the thermoplastic polymer where the crosslinker may be a thermoset, e.g., a silicone material. A thermoset material cannot be melted after crosslinking. An amount of crosslinker may be in a range of greater than 0 up to 50 vol. % of total ink.

In one example, an additive(s) may be added to a PEI ink for initiating a crosslinking of the PEI polymer in response to one or a combination of the following triggers: an elevated temperatures, irradiation (e.g., UV), an environmental trigger (e.g., moisture), etc.

In some approaches, an ink may include a polymerization initiator. For example, a polymerization initiator may include a photoinitiator, a thermal initiator, etc.

According to one embodiment, additive manufacturing of the thermoplastic polymer by the described process and conditions yields a deterministic structure with minimal change in physical and chemical properties of the original thermoplastic polymer compared to the printed thermoplastic polymer.

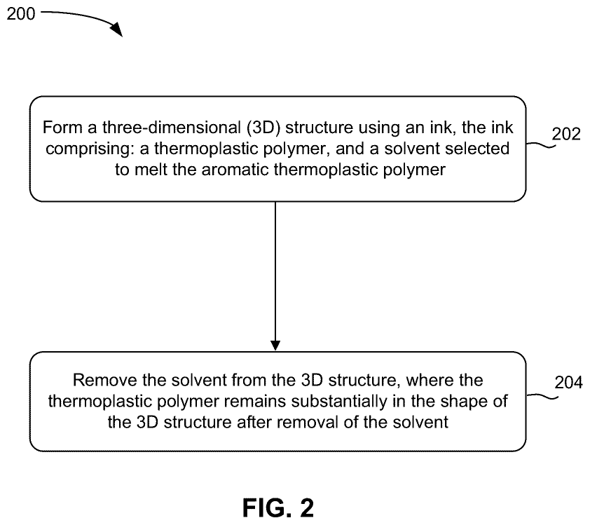

According to one embodiment, an ink may be prepared for extrusion-based additive manufacturing techniques (e.g., DIW) for forming a 3D structure. FIG. 2 shows a method 200 for forming a 3D structure that includes a thermoplastic polymer matrix, in accordance with one embodiment. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative embodiments listed herein. Further, the methods presented herein may be carried out in any desired environment. Moreover, greater or fewer operations than those shown in FIG. 2 may be included in method 200, according to various embodiments. It should also be noted that any of the aforementioned features may be used in any of the embodiments described in accordance with the various methods.

According to one embodiment, the method 200 begins with step 202 including forming a 3D structure using an ink. In one approach, the forming includes extruding an ink to form an extruded filament, where the 3D structure is a geometric arrangement of the extruded filament. The ink includes a thermoplastic polymer and a solvent selected to melt the thermoplastic polymer. The thermoplastic polymer preferably has a chemical structure that includes a repeating unit having at least one aromatic rings. In some approaches, the repeating unit of the thermoplastic polymer may have up to eight aromatic rings.

In one approach, the method for forming a 3D printed structure includes using the ink for DIW techniques. An ink for DIW techniques is comprised of a thermoplastic polymer and a solvent that remains as a liquid until the solvent is removed. The liquid ink is extruded through a nozzle and forms an extruded filament. The removal of solvent from the extruded filament produces the liquid to solid phase transition. Extrusion is controlled by the viscosity of the ink. The ink has a sufficiently high viscosity to prevent it from flowing out of the cartridge without external force applied to the cartridge. The flowing ink may be extruded as a continuous filament thereby a forming self-supporting geometric arrangement of the extruded filament(s) according to a predefined pattern.

In another approach, an ink may be formed in a mold, caste, thin film, etc. A 3D structure comprising the thermoplastic polymer may be formed into a predefined shape using a mold, die, template, etc.

Operation 204 of method 200 includes removing the solvent from the formed structure, e.g., extruded ink, molded ink, etc. The thermoplastic polymer substantially remains in the shape of the 3D structure after partial removal of the solvent at the surface. The thermoplastic polymer ink forms a thermoplastic polymer material after removal of the solvent. In one approach, upon exposure to the external environment after extrusion, the solvent present in the extruded filament evaporates from the thermoplastic polymer in the extruded filament resulting in the formation of a solid thermoplastic polymer material in the shape of the extruded ink. The extruded thermoplastic polymer may be in the shape of a predefined 3D structure that is characterized by a geometric arrangement of the filaments. The loss of the solvent loss via evaporation occurs initially at the surface of the extruded filament. In one example, the loss of THF from a PEI polymer in turn de-coordinates the polymer chains turning the material back into a solid polymer. The time scale of the transition to a solid after extrusion is nearly instantaneous.

In conventional extrusion-based printing processes, forming overhangs and unsupported regions of a 3D structure with a liquid ink is not possible; however, as described herein, the near instantaneous transition of the extruded ink comprising a thermoplastic polymer and solvent from a liquid to a solid upon removing solvent from the extruded ink by evaporation, diffusion, etc., allows the formation of overhangs and unsupported regions of a 3D structure. A thermoplastic polymer ink can be set in a solid form by simply removing the solvent from the extruded ink. Curing the formed structure is not needed. The thermoplastic polymer remains in substantially the same shape after removing the solvent from the extruded ink. Moreover, the near instantaneous transition of the extruded ink to a solid form allows complex geometric structure to have appreciable mechanical strength just after extrusion from the nozzle in the presence of conditions that rapidly remove the solvent from the extruded ink.

The time duration of the extruded material transitioned back to a solid material may be nearly instantaneous, e.g., less than 5 seconds. The duration of time for the material to transform completely into a solid throughout the extruded part, where the solvent is essentially evaporated from the material, may be in a range of 2 hours to 72 hours.

According to another approach, the operation of removing the solvent from the extruded polymer material may include a diffusion operation. In one approach, the material may be extruded into a water bath, and since some selected solvents, such as THF, have a higher affinity for water than the polymer, the solvent will diffuse out of the extruded thermoplastic polymer material. The rate of the extruded material turning into a solid may be increased by changing the media in the bath to promote efficient solvent exchange. In some approaches, complete removal of the solvent by exchange of the solvent with water in the extruded material may occur at a faster rate than evaporation of the solvent from the extruded material exposed to air.

In various approaches, the temperature for extrusion of the ink in DIW may be at ambient temperature. In some approaches, the temperature for extrusion of the ink may be an elevated temperatures to allow faster evaporation of the solvent post extrusion, e.g., a temperature in a range of greater than room temperature up to 50° C. In some approaches, the temperature for extrusion of the ink may be a lower temperature down to the freezing point of the selected solvent, e.g., for THF, 0 to 50° C.

In some approaches, the pressure of the environment during extrusion of the ink may be adjusted to increase the rate of evaporation of the solvent. In one approach, air may be blown onto the extruding filament of ink and in order to increase the rate of evaporation of the solvent from the extruded ink. In one approach, an airstream may be positioned on the extruding filament to increase the diffusion of solvent out of the extruded filament. In some approaches, adjusting the pressure may in turn adjust the evaporation rate of the solvent from the extruded ink. In one approach, decreasing the pressure of the environment at the nozzle extruding the ink may increase the evaporation rate. In another approach, increasing the pressure of the environment at the nozzle extruding the ink may decrease evaporation For example, in one approach, a decrease of pressure at the extrusion site may increase the evaporation rate by a theoretical factor of two (i.e., double the rate of evaporation of solvent from the extruded ink at ambient pressure).

According to one embodiment, an ink for DIW, DP, etc. includes a thermoplastic polymer and a selected solvent that is configured to diffuse out of the extruded thermoplastic polymer quickly to set the printed structure. Under ambient conditions, solvent removal may be accomplished by evaporation of solvent from the surface of the part by exposure of the part to air. In one approach, diffusion of the solvent out of the extruded polymer may be assisted through use of a fan directed toward the print nozzle and/or part. For example, a compressed airline may allow the extruded ink to set shortly after extrusion. In some approaches, in the absence of an applied airstream directed at the nozzle, e.g., a compressed airline, a fan, etc., an extruded filament may intentionally droop after extrusion when additional layers of extruded filament are added sequentially on top of the extruded filaments.

In another approach, evaporation of the solvent may include a slight decrease in ambient pressure and/or slight increase in ambient temperature. In one approach, evaporation of the solvent may include diffusion of the solvent out of the polymer assisted through use of increased ambient temperature, decrease in ambient pressure, a combination of an increased ambient temperature and decrease in ambient pressure, etc.

Furthermore, in some approaches, a rapid increase in bulk modulus of the thermoplastic/solvent ink may be achieved by extraction of the primary solvent-melt solvent though use of a secondary solvent bath the allows immersion of the printer nozzle and substrate. The secondary solvent may preferably be miscible with the primary selected solvent to drive extraction and not react, swell, solvent-melt, etc. the thermoplastic/solvent mixture. In one example, a series of solvent systems may include THF as selected solvent, i.e., primary solvent, to function as a solvent-melt solvent with PEI and water as secondary solvent to function as a diffusion solvent for removing THF from the extruded PEI material. A secondary solvent bath may include additives such as salts and/or surfactants to improve the solvent extraction or resulting printed structure.

In one approach, a structure formed by an ink may allow assisted rapid diffusion of the solvent out of the polymer that may have features such as an overhang, unsupported structures, etc. printed using the DIW technique that results in a solid thermoplastic polymer material having a shape that includes overhangs, unsupported features, etc.

In one approach, an ink having a high viscosity of a solvent-melt may be loaded into an ambient temperature extrusion system that are known to those familiar with the art and deposited into defined structure by a multi-axis positioning system, 3D printer, etc. Structure retention may be achieved by the rapid removal of solvent from the surface of the deposited bead on the time scale of a few seconds. Solvent mobility may be limited by the polymer structure and further solvent removal may allow multiple layers of the described material to be placed on top of each other to produce the additively manufactured self-supporting structure.

The rapid increase in bulk modulus from this approach allows structures with significant overhangs or unsupported regions to be produced, much like FDM 3D printing. This ability to produce overhangs and unsupported regions is typically not a feature of structures produced by DIW without the use of quick curing thermosets or quick-set materials.

In one embodiment, extrusion of an ink may form a structure comprised of composites that are composed partially of a thermoplastic polymer (e.g., Ultem®, PEI, etc.).

In one embodiment, a thermoplastic structure has mechanical strength that does not deform at high temperatures. A product being a structure formed via DIW is comprised of material that has physical properties including mechanical strength. At elevated temperatures, the thermoplastic polymer structure formed as described herein demonstrates resistance to thermal degradation for longer periods of time compared to thermoplastic polymer structures formed using conventional high temperature processing techniques due to the lack of the high temperature processing. It is well understood that plastic material degrades at high temperatures over time. In sharp contrast, a structure formed using the composition of the thermoplastic polymer described herein is resistant to thermal degradation. The structure is formed without prior thermal degradation steps. For example, heating a structure formed by conventional methods to 400° C. causes a thermal degradation of the material, whereas the material of a structure formed by methods described herein has not undergone degradation at temperatures of about 400° C.

In another approach, adhesion between the printed layers does not adversely affect material properties. The underlying layer is solid and includes some solvent, the solvent of the recently extruded layer diffuses into the underlying layer from which solvent has recently diffused away. In extrusion printing of conventional materials, an interface between extruded layers may be defined by the material of one layer on top of the material of a previously extruded layer. In stark contrast, the interface between the layers of extruded thermoplastic polymer/solvent inks, as described herein, demonstrates a homogenous material without definition of the joining layers due to the solvent of the recent layer diffusing into the previously extruded layer (having solvent already evaporated) resulting in a homogenous material between the layers. Without wishing to be bound by any theory, the solvent diffusion between the layers strengthens the adhesion between the layers, i.e., the interface between the layers.

### Experiments

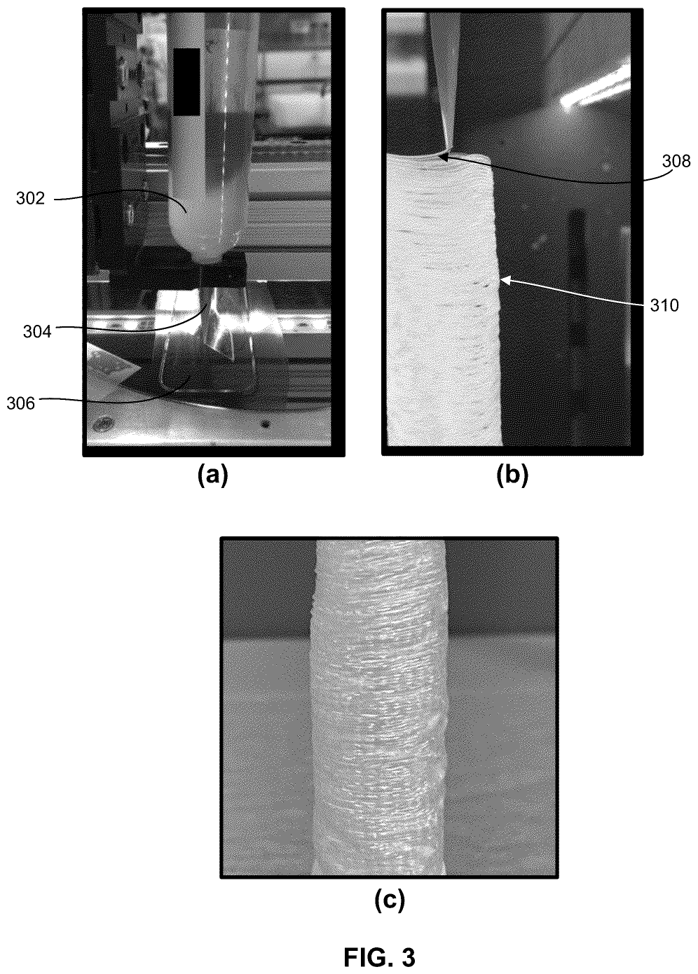

FIG. 3 depicts the process of extrusion of a continuous filament of ink (1:1 Ultem® resin/THF ink) using DIW techniques to form a self-supporting cylindrical structure. The solvent is evaporated from the extruded filament at ambient conditions without including an applied airstream. Part (a) depicts the ink contained in cartridge 302 having a nozzle 304 directed toward the substrate 306. Part (b) depicts the extruding of a continuous filament 308 in a layered circular pattern to form a self-supporting (e.g., free standing) cylindrical structure 310. The extruded filament may intentionally droop after extrusion when additional layers of filament are added sequentially. Part (c) depicts the solid self-supporting structure after evaporation of the solvent from the extruded composite material. The solid structure has a shape determined by the pattern of the extruded filaments.

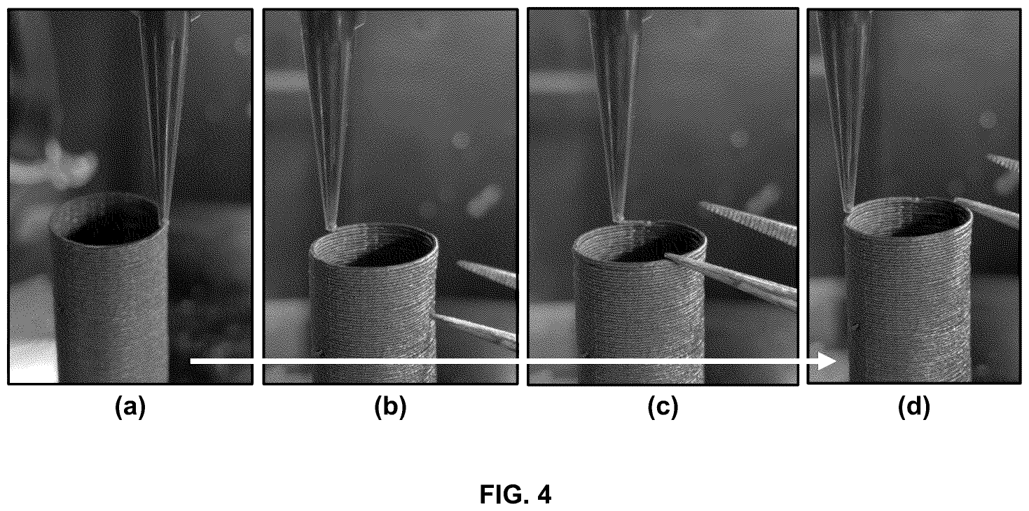

FIG. 4 is series of images of extruding an ink comprising a boron carbide composite (Ultem1010/THF+40 vol. % boron carbide). A green body in the shape of a self-supporting cylinder was formed by extruding the boron carbide composite ink through a nozzle having a diameter of about 250 μm. An airstream was directed at the nozzle during extrusion to allow an increased rate of evaporation of the THF solvent. Parts (a) and (b) show the ink being extruded from the nozzle in a uniform circular manner above the previously extruded material. The images show an absence of droop from the previously extruded material thereby indicating the extruded material is transitioning to a solid phase almost instantaneously. Parts (c) and (d) show that tapping the extruded material with forceps demonstrated rapid solidification of the composite such that the shape of the extruded material was not altered by the tapping. The formed green body was then subsequently sintered at a high temperature to form a ceramic part.

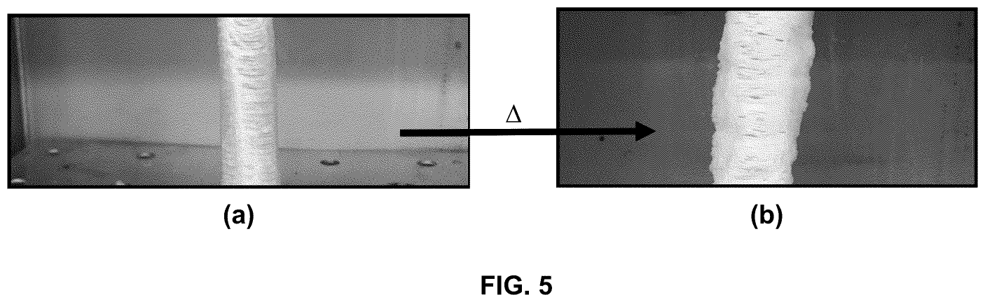

FIG. 5 depicts images of a structure formed by extrusion of the ink in a closed environment so that the solvent (e.g., THF) remains present in the material of the formed structure (part (a)). As printed, the filament forms a structure, and the extruded filaments maintain an amount of THF (evaporation is slowed). Heating (A) the structure to a temperature that is above boiling point of THF, about 80° C., the THF is rapidly evaporated away from the material of the structure thereby leaving voids in the material giving the appearance of foam. As shown in the image of part (b), the material expanded about 1.5× of the original extruded filaments, and has same mechanical properties of a foamed Ultem, with increased porosity.

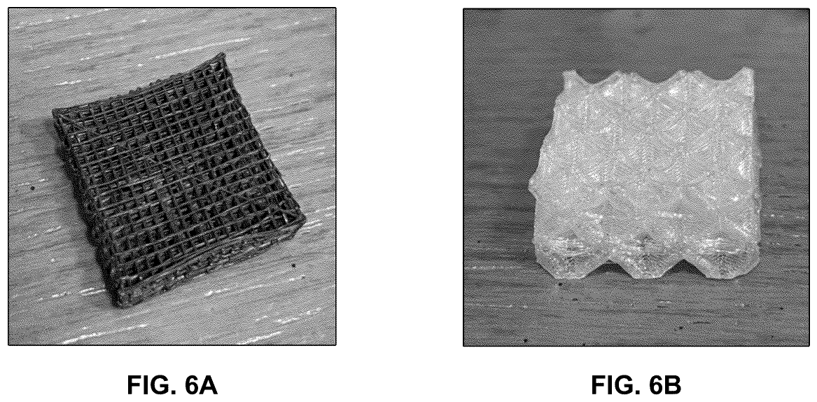

The images of FIGS. 6A and 6B depict structures formed using the ink in DIW processes, Ultem®/THF in a complex lattice pattern using DIW processes (FIG. 6A) and a complex geometric pattern (FIG. 6B). Each structure is comprised of a thermoplastic polymer that has the same chemical and physical properties as the thermoplastic polymer included in the ink before formation of the 3D structure.

### In Use

Ultem® PEI is widely used in aerospace, automotive and biomedical industries due to its high strength and thermal stability. Various embodiments as described herein include additive manufacturing of Ultem® PEI at entirely ambient conditions for a wider range of applications thereby resulting in significant financial value.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments but should be defined only in accordance with the following claims and their equivalents.

What is claimed is:

1. An ink, comprising:
a thermoplastic polymer; and
a solvent selected to melt the thermoplastic polymer.

2. The ink as recited in claim 1, wherein the thermoplastic polymer is selected from the group consisting of: a polyetherimide and a polycarbonate.

3. The ink as recited in claim 1, wherein the chemical formula of the thermoplastic polymer in the absence of the solvent is the same as the chemical formula of the thermoplastic polymer solvated with the solvent.

4. The ink as recited in claim 1, wherein the solvent is selected according to the chemical structure of the thermoplastic polymer.

5. The ink as recited in claim 1, wherein the thermoplastic polymer comprises a repeating unit having at least one aromatic ring.

6. The ink as recited in claim 1, wherein the thermoplastic polymer is an aromatic polyetherimide, and the solvent is tetrahydrofuran.

7. The ink as recited in claim 1, wherein the thermoplastic polymer is a polycarbonate, and the solvent is acetone.

8. The ink as recited in claim 1, wherein a weight ratio of the thermoplastic polymer to the solvent is in a range of 100:1 to 1:100.

9. The ink as recited in claim 1, comprising a co-solvent that is different than the solvent selected to melt the thermoplastic polymer.

10. The ink as recited in claim 1, comprising an additive.

11. The ink as recited in claim 10, wherein the additive is a filler.

12. The ink as recited in claim 11, wherein the filler is selected from the group consisting of: fibers, powders, and combinations thereof.

13. The ink as recited in claim 11, wherein the filler is a pre-ceramic material.

14. The ink as recited in claim 11, wherein an amount of filler is less than 70 volume % of the total volume of the ink.

15. The ink as recited in claim 10, wherein the additive is selected from the group consisting of: a crosslinking agent, a thermoset material, a photoinitiator, a thermal initiator, and a combination thereof.

16. A product formed by extrusion of the ink as recited in claim 1, the product comprising:
a three-dimensional structure having physical characteristics of formation by extrusion,
wherein the structure is self-supporting,
wherein the structure comprises a material that is resistant to thermal degradation at a temperature up to 500° C.

17. The product as recited in claim 16, wherein the physical characteristics of the structure includes a series of layers having an interface between each adjacent layer, wherein the interface is a homogenous form of the material.

18. A method, comprising:
forming a three-dimensional (3D) structure using an ink, the ink comprising:
a thermoplastic polymer; and
a solvent selected to melt the thermoplastic polymer; and
removing the solvent from the 3D structure, wherein the thermoplastic polymer remains substantially in the shape of the formed 3D structure after removal of the solvent.

19. The method as recited in claim 18, wherein removing the solvent comprises evaporating the solvent using at least one process selected from the group consisting of: exposing formed 3D structure to air, exposing the formed 3D structure to air during a change in pressure, exposing the formed 3D structure to an elevated temperature, and diffusing the solvent from the formed 3D structure into a second solvent that is miscible with the solvent.

20. The method as recited in claim 18, wherein the forming includes extruding the ink to form an extruded filament, wherein the 3D structure is a geometric arrangement of the extruded filament.

21. The method as recited in claim 18, wherein the thermoplastic polymer is an aromatic polyetherimide and the solvent is tetrahydrofuran.

22. The method as recited in claim 21, wherein the aromatic polyetherimide is an Ultem® thermoplastic polymer.
